(19) United States
(12) Patent Application Publication
(10) Pub. No.: US 2017/0323163 A1
(43) Pub. Date: Nov. 9, 2017

(54) SEWER PIPE INSPECTION AND DIAGNOSTIC SYSTEM AND METHOD

(71) Applicant: City of Long Beach, Long Beach, CA (US)

(72) Inventor: Kee Eric Leung, San Marino, CA (US)

(21) Appl. No.: 15/587,693

(22) Filed: May 5, 2017

Related U.S. Application Data
(60) Provisional application No. 62/332,748, filed on May 6, 2016.

(51) Int. Cl. G06K 9/00; G06K 9/62; H04N 9/04; H04N 7/18; H04N 9/73; G06T 5/00; G06T 3/40; H04N 5/232; G06K 9/66; H04N 5/225

(52) U.S. Cl. CPC G06K 9/00771; G06K 9/6263; G06K 9/6267; H04N 9/04; H04N 7/183; G06K 9/66; H04N 9/73; G06K 9/00744; G06T 5/002; G06T 3/4046; H04N 5/23293; G06T 2207/10024; H04N 2005/2255; G06T 2207/10016

(57) ABSTRACT

A method is disclosed for interrogating enclosed spaces such as sewers and the like by commanding a camera to travel through the enclosed space while transmitting the video feed from the camera to a remote location for viewing and processing. The processing involves image manipulation before analyzing frames of the video using a neural network developed for this task to identify defects from a library of known defects. Once a new defect is identified, it is inserted into the model to augment the library and improve the accuracy of the program. The operator can pause the process to annotate the images or override the model's determination of the defect for further enhancement of the methodology.

### CROSS-REFERENCES TO RELATED APPLICATIONS

This application claims priority from U.S. Application No. 62/332,748, filed May 6, 2016, the contents of which are fully incorporated herein by reference.

### BACKGROUND

The challenge in evaluating the condition of sewer pipelines is the ability to easily access and physically observe a pipe's condition while it remains underground. As these pipelines continue to age and become susceptible to damage and deterioration over time, it is important for a utility owner to assess the condition, maintain, plan, and upgrade the components of the sewer system. For many owners, closed circuit television (CCTV) inspection is essential to determine a pipeline's condition. As part of the evaluation process, it is often desirable to find a correlation between pipe age and Pipeline Assessment Certification Program (PACP) score to predict the failure of a pipe. For example, the use of the NASSCO PACP score for pipes can be used to estimate the capital improvement program costs to rehabilitate sewer pipes for the near future. One of the PACP scoring options is the four digit Quick Score, which expresses the number of occurrences for the two highest severity defects (5 being a severe defect requiring attention and 1 being a minor defect.

The process of reviewing video of the pipe's condition is quite tedious and monotonous. Much real time processing of the data is necessary to allow the evaluation of the pipe's condition, and during this monotonous time consuming process errors are frequently encountered. Errors included missing access points, not finishing a continuous defect, not inputting a clock position for a defect, and inputting a point defect as a continuous defect. In one year of surveys, a five percent error rate was discovered due to operator input error.

Another issue that is present in the analysis is the apparent lack of uniform progression as a pipe deteriorates. It would be expected that a pipe rated as a “2” would progress to a “3,” then a “4,” and finally a “5.” However, data often suggests that a pipe may progress from a “2” to a “5” due to the lack of surveying each pipe over time or more rapid deterioration than expected. This leads to inconclusive results in predicting the correlation of age with pipe condition for a set of pipelines. This may also be due to other factors that contribute to pipe deterioration, such as surrounding soil conditions, soil properties, proximity to vegetation, water quality, and construction quality during installation. Most of these factors are difficult to parameterize in order to evaluate how they might contribute to the deterioration of the pipes.

The inconsistent scoring and evaluation of the pipelines are problematic to municipalities and utility providers tasked with the maintenance of the pipes. Reasons for shifting PACP scores include defects being overlooked, different codes being used by different operators, and defects being coded in the incorrect field. Scoring by different operators is a large component of the inconsistency, where subjective evaluation is required. Further, a defect may be overlooked by one operator but more closely inspected by a second operator. The need for more reliable evaluation techniques that can properly identify critical or soon-to-be critical conditions is essential to prevent more catastrophic failures and loss of service/expensive repairs.

### SUMMARY OF THE INVENTION

The present invention is a test and evaluation system that automatically detects defects in fluid pipes, and processes in real time images from pipes such as sewage pipes that are generated by CCTV systems to evaluate the images for defects. The system further classifies the defects, displays them and stores information about them for further analysis.

To find and analyze the defect, the present invention passes each image obtained from a closed circuit television feed through an image processing unit. This unit extracts various features that the system uses in the detection and classification step. In the feature extraction step, text and other indicia are removed to recover the raw image. Then, various segmentation methods are utilized including Morphological Segmentation based on Edge Detection (MSED) and Top-Hat transforms (white and black). The textual information is extracted from the CCTV images using, for example, the Contourlet transform. These extracted and filtered features along with statistical features constitute a feature vector.

Next, the present invention performs a detection and classification step. The feature vectors generated in the previous step will now be the input to various state-of-the-art ensemble methods and neurofuzzy classifiers that score the feature anomalies detected. The system combines and normalizes the output scores and uses a decision tree and K-nearest neighbors algorithm to detect and categorize any defect. The machine learning models are fine tuned using experimentation, and the system can be designed to match a particular pipe network. It is adaptable to different camera systems and operating systems, but is preferably designed for a specific camera system and a specific operating system.

An object of the invention is to include a user-friendly graphical interface with easy-to-follow operational modes. The output of the software is the detected defects. Defects are observed in real time as the camera moves through the pipe or by accessing a mode that allows a user to obtain a list of defects detected. For each defect, a display shows an alphanumeric of the pipe defect, pipe size, pipe material, defect location along the pipe, the defect location by clock position (angular), and the type of defect as represented by a code. The system displays the output in real-time as the camera moves and also stores the information for future analysis. The defect coding is based on the pipeline assessment Certification Program (PACP) manual and pipe surveys provided by the Long Beach Water Department.

Because environmental and imaging noises can reduce the accuracy of this automated software, the present invention incorporates various advanced image processing filters to reduce the effects of such noise. Materials such as wastewater flow, debris, and vectors that can be found in active sewer pipelines contribute to the environmental noise. Thus, the present invention models such noises and trains the software models to specifically recognize and eliminate such noises.

In a preferred embodiment, the system and method of the present invention utilizes the NASSCO PACP Code Matrix. This grading system uses defect nomenclature such as “crack,” “fracture,” “failure,” etc., with modifiers for characteristics of each main category such as “longitudinal,” “circumferential,” “spiral,” and the like. Each defect is also assigned a grade as to the severity of the defect between 1 and 5.

A key feature of the present invention is a single path that each image travels in the evaluation process. That is, every image passes through a set of image processing techniques and then the results go through a single neural network. If that main network detects a defect, then that image is passed through one neural network per defect, i.e. one for cracks, one for misalignment, etc. Each network produces a score and all scores are combined to label (classify) which one of the defects exists in the image. So first there is a general detection (to detect a defect) and then the system classifies what kind of defect is present.

### BRIEF DESCRIPTION OF THE DRAWINGS

FIG. 1 is a photograph depicting a sewer pipe with no discernable defects;

FIG. 2 is a photograph depicting a sewer pipe with a defect;

FIG. 3 is a processed image that eliminates the non-essential data;

FIG. 4 is a flow chart of the training phase of the methodology; and

FIG. 5 is a flow chart of the autopipe phase of the methodology.

### DETAILED DESCRIPTION OF THE PREFERRED EMBODIMENTS

The present invention uses both hardware and software to inspect, diagnose, and catalog defects in subterranean pipes such as sewer systems and the like. The use of automated motorized cameras using closed circuit television that are controlled above ground in video surveillance vans or other remote stations are well known in the art. This invention improves upon such systems by making the task of reviewing the live feed of camera more effective and by iteratively improving the recognition of the presence and type of defects through a learning mode of the software.

The system is divided into two components: a training component and a runtime component. Training is executed in a Cloud based computing environment, whereas the runtime element of the invention occurs while the operator analyzes the video feed for defects as the camera moves along the pipe.

In the training step, the software analyzes images of defects in sewage pipes in order to learn how to differentiate between image frames containing visible defects and frames where no defects are visible. This is accomplished by annotating visible defects in a database of videos and having the software recognize those annotated defects as a catalog of all possible defects, and anything not annotated is interpreted by the software as not being a defect. This “training” aspect of the invention is ongoing and allows the process to continuously improve and become more efficient as the program learns what imagery is a defect and what is not. As a defect appears in the video, it is labeled when it first appears in the center of the frame far from the camera. This ensures the potential early detection of the defect, which is important to the invention. If a defect is not detected early, the camera may in many cases need to be stopped, backed up into position, and restarted again. This process needs to be avoided if the task is to carried out in an efficient and expedient manner. Once the defects are identified by the operator and the type annotated, the images are extracted using a computer vision program and store the image on a storage disk.

To extract the images, a three step process is followed. First, the image is cropped so that the center of the pipe is not displayed (e.g., the horizon inside the pipe), focusing on the near field image adjacent the camera. Since the center view of the image is typically dark and does not yield usable information, the excision of this portion of the image serves two purposes: a) it focuses the operator's attention on the portion of the image where defects can actually be detected and evaluated; b) and it reduces the computer processing on the image by eliminating a large portion the image, allowing the processing power to be concentrated on the remaining portion of the image. After the image has been cropped, a color correction is applied to the image to emphasize the discolorization or contrast that results from a defect as opposed to other markings and debris on the wall of the pipe that could appear to be a defect. Once the colorization processing has occurred, the edge detection algorithm focuses on the edges of the defect and creates an outline of the defect along the edge. This colorized outline is resized and stored in a defect database used to train the system for optimization.

The above-identified database is used to train a convolutional neural network (CNN), where the model is trained to detect whether a defect exists in a camera feed image. If the CNN model determines that a defect does exist, a second model can be used to classify the type of defect from among a set of classifications of defects previously established by the model. Since neural network training is very computationally taxing and therefore expensive, this step is best to a powerful computing unit or cloud computing facility. This is because the performance of the training step depends on the amount of processed images—the more images that are cataloged and the more types of defects that are recognized by the system, the more accurate the model will be at detecting and evaluating defects in real time.

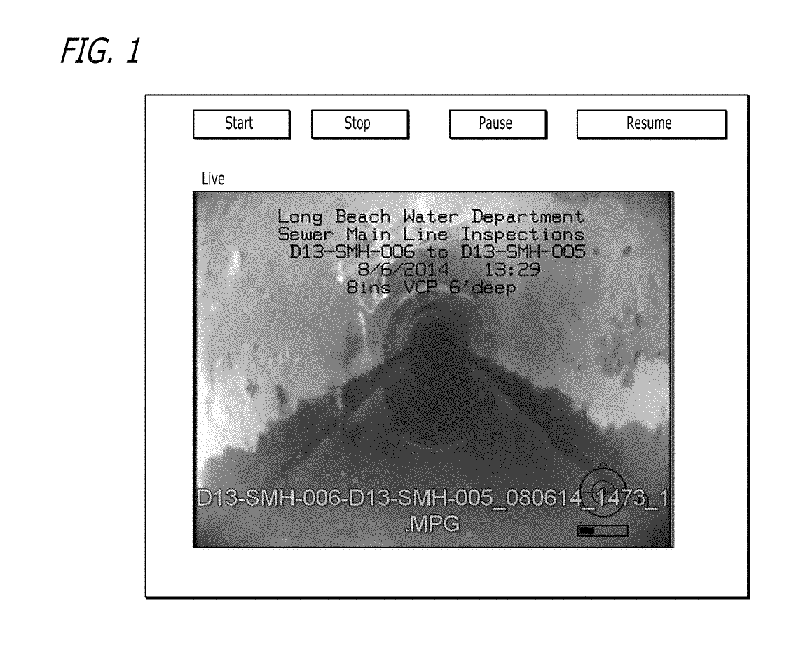

Once the training phase of the invention is at least reached a level where the model is operational, the runtime phase of the invention can be initiated. In the runtime step, the results of the training phase, namely the trained neural network model, is employed in real time to evaluate a camera feed of a sewer system. The system runs on a computing device typically in an inspection vehicle under the supervision of an operator. A monitor displays a camera feed of a sewer pipe, such as that shown in FIG. 1, as it moves along the pipe. The camera is mounted on a remote controlled cart that illuminates the pipe downfield while capturing high resolution images of the pipe's interior as it moves from one end of the pipe to the other. Software processes the displayed image in real time, and the operator controls both the camera and the cart moving along the pipe. Each image captured by the camera is processed by the software and compared by the model to the library of defects to determine if a defect is present in the field of view.

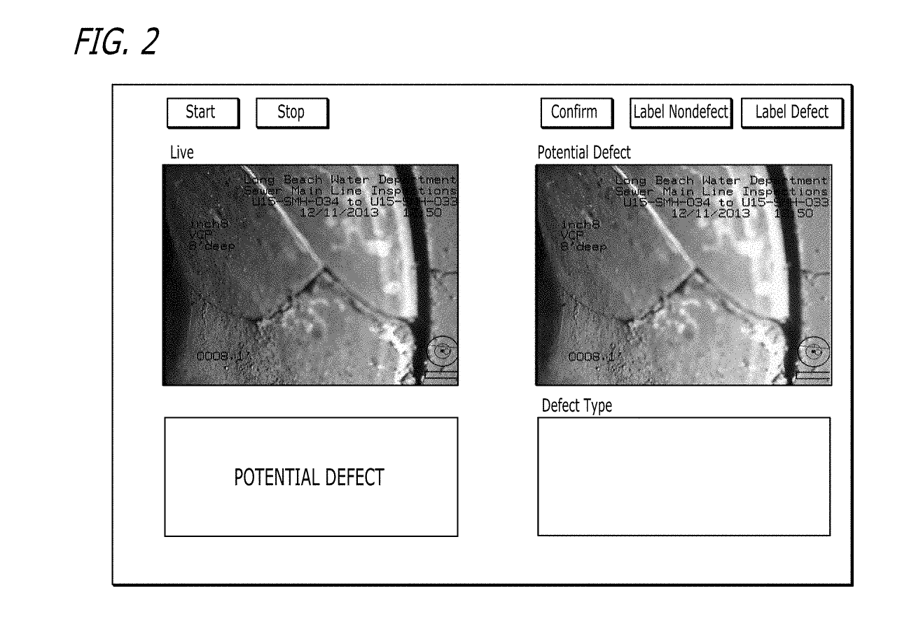

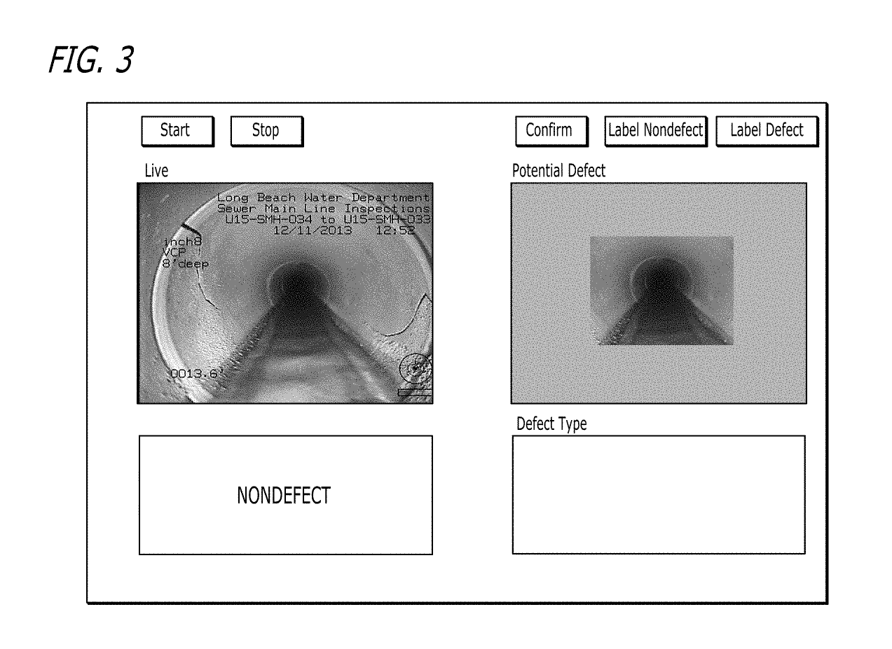

As the images are received, the processing detailed above is applied to the images. As shown in FIG. 2, at some point a defect will be identified. The software crops the image to exclude the enter portion of the image, that is the portion shown in FIG. 3 is excluded from the image to concentrate on the remaining portion of the image. The cropped image is subjected to color correction and edge enhancement, and then the image is resized. The software processes the image by passing it through the model and the model returns a determination whether a defect is detected. If a defect is detected, the defect is characterized by type according to the software, and this defect is stored and added to the database for future determination of defects. If no defects are detected, the program provides no input as the camera continues to provide images to the monitor for the operator. Every time the camera moves, the software continues to analyze the frames it receives according to the model for known defects. The operator can also pause the program, causing the process to continue without processing any new images and without flagging any defects in the video stream.

Operators can override or add input to the determinations made by the model to correct or revise decisions made by the software. That is, if the program incorrectly identifies a defect that the operator concludes is an artifact, debris, marking, or other discoloration on the pipe wall, the operator will characterize the image as a non-defect to further improve the model. The CNN receives this data and incorporates it in the revised model for future predictions moving forward.

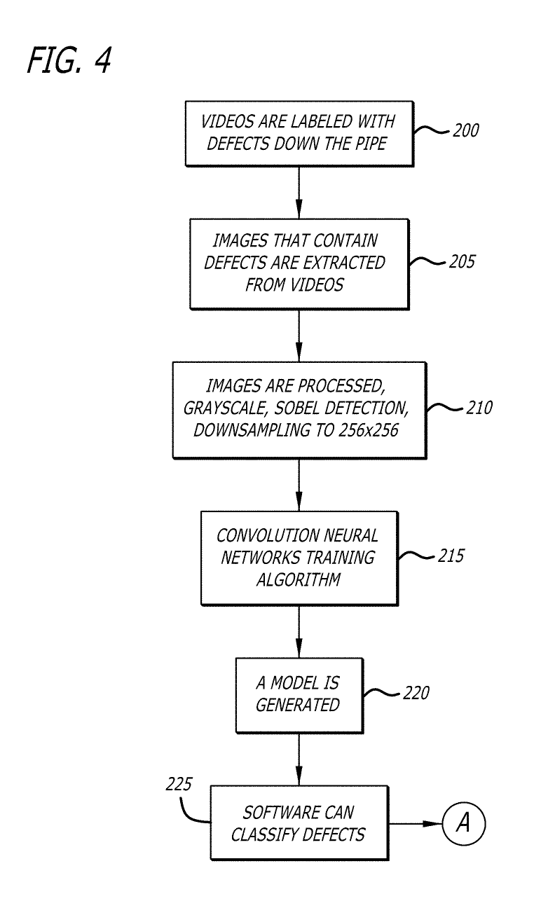

FIG. 4 is a flow chart illustrating the steps of the training phase of the present invention. In step 200, a set of videos are collected with known defects for analysis by the software of the present invention. The images that contain the defects are extracted from the videos in step 205, and the extracted images are processed in step 210. The processing involves grayscale conversion, edge processing such as sobel detection, and resizing the image such as downsampling the image to 256×256 pixels. In step 215, the processed image of the defect is fed to the Convolutional Neural Network training algorithm for developing a learning model of the known defects in step 220, which is then used in step 225 to identify and classify defects in new videos.

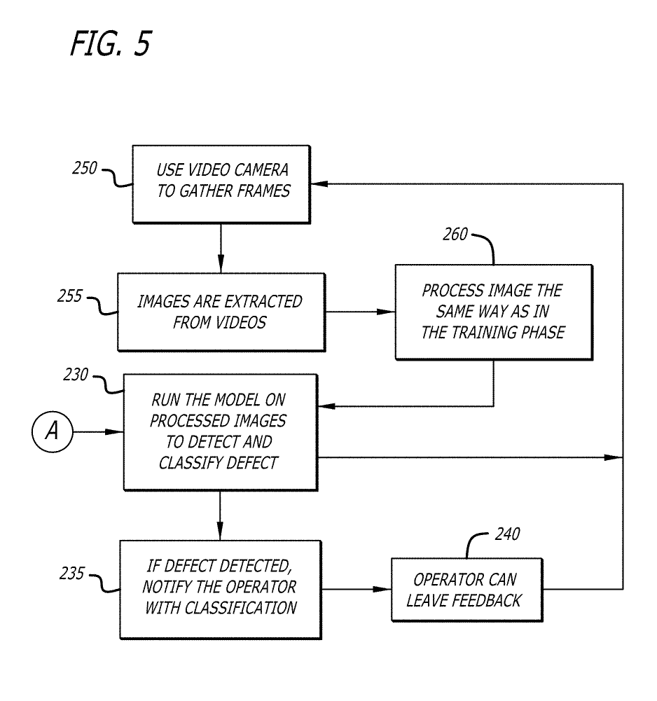

FIG. 5 is a flow chart of the runtime phase of the present invention, where the model developed in the preceding paragraph is used to detect and catalog new defects from new video. In step 250, the operator instructs the camera and the software to initiate the investigation of a new sewer as the software captures images from the camera feed in real time and the video is sent to the vehicle where it is viewed by the operator. In step 255, the frames of video are extracted from the feed and processed in step 260 in the same manner as in step 210 in the training phase of the invention. In step 230, the model created in step 220 is used with new images from video collected in real time from a camera feed of sewer investigations. If a defect is detected by the model from the images in the camera feed, the operator is sent a notification on the monitor in step 235 alerting the operator of the presence of a detected defect. The operator may stop the camera and annotate the data to include feedback relating to the defect in step 240, including overriding the model if the operator determines that the model has incorrectly identified a defect or mischaracterized a defect in any way. The process continues as the camera moves along the pipe until the camera reaches the end of the pipe and the length of pipe has been analyzed for defects.

We claim:

1. A method for interrogating an integrity of an inner surface of a wall of an enclosed space, comprising the steps of:
commanding a video camera to move along the enclosed space;
communicating a video feed from the camera to a remote location;
extracting frames of the video feed for detecting a presence of defects;
processing the extracted frames using an image processing method;
using a neural network model to analyze frames against known defects;
alerting an operator when the neural network model identifies a defect; and
incorporating the newly detected defect into the neural network model to improve future model performance.

2. The method for interrogating an integrity of an inner surface of a wall of an enclosed space of claim 1, wherein the processing includes removing a central portion of the extracted frame and analyzing a remaining portion of non-extracted frame for defects.

3. The method for interrogating an integrity of an inner surface of a wall of an enclosed space of claim 2, wherein the processing further comprises applying a color correction and a resizing of the image.

4. The method for interrogating an integrity of an inner surface of a wall of an enclosed space of claim 3, wherein the operator may introduce feedback of an identified defect, said feedback including a confirmation or negation of the identified defect.

5. The method for interrogating an integrity of an inner surface of a wall of an enclosed space of claim 2, wherein the enclosed space is a sewer pipe.

6. The method for interrogating an integrity of an inner surface of a wall of an enclosed space claim 1, wherein the commanding step is preceded by creation of a model using a convolutional neural network using previously extracted and processed images of enclosed spaces.

7. The method for interrogating an integrity of an inner surface of a wall of an enclosed space of claim 1, wherein the neural network model further classifies the detected defect as a particular type.

8. The method for interrogating an integrity of an inner surface of a wall of an enclosed space of claim 3, wherein the processing further comprises edge enhancement of the detected defect prior to resizing.

9. The method for interrogating an integrity of an inner surface of a wall of an enclosed space of claim 1, wherein a computer processing is enhanced by removing a portion of the image prior to applying the model to the frame, and where the monitor displays the image without the removed portion of the image.
